(19) United States
(12) Patent Application Publication
(10) Pub. No.: US 2012/0072831 A1
(43) Pub. Date: Mar. 22, 2012

(54) METHOD FOR CREATING A MULTI-LINGUAL WEB PAGE

(75) Inventor: Po-Yi Li, Seoul (TW)

(73) Assignee: GEMTEK TECHNOLOGY CO., LTD, Hsinchu (TW)

(21) Appl. No.: 12/883,336

(22) Filed: Sep. 16, 2010

(51) Int. Cl. G06F 17/00

(52) U.S. Cl. 715/236

(57) ABSTRACT

A computer-implemented method includes: automatically identifying to-be-rendered elements in a source electronic document that is suitable for rendering a web page in a first human language, each of the to-be-rendered elements including to-be-rendered text content in the first human language; generating a list of object elements corresponding to the to-be-rendered elements, the list including translations of the to-be-rendered text in a second human language; and automatically converting the source electronic document into a multi-lingual electronic document by modifying the to-be-rendered elements into the object elements, each of which includes the to-be-rendered text content, and by inserting into the source electronic document instructions for causing a client device with a browser to refer to the list when rendering the multi-lingual web page such that the multi-lingual web page contains the to-be-rendered text contents of the object elements in a selected one of the first and second human languages.

### BACKGROUND OF THE INVENTION

1. Field of the Invention

The present invention relates to a method for creating a web page, more particularly to a method for creating a multi-lingual web page.

2. Description of the Related Art

Nowadays, most network devices, such as network routers, have graphical user interfaces (UI) for user configuration of the network devices through a web browser, such as the Internet Explorer. As the network devices are offered in different regions using different languages, most of the network devices are configurable through a multi-lingual UI.

Conventionally, creation of a multi-lingual hypertext markup language (HTML)—based UI with, say, 10 language versions involves creation of 10 HTML documents and nine translation processes. Furthermore, subsequent updating of contents of the multi-lingual HTML-based UI requires 10 updating processes, which can be very time-consuming and inefficient.

### SUMMARY OF THE INVENTION

Therefore, an object of the present invention is to provide a method for creating a multi-lingual web page that is relatively less time-consuming and is efficient to update.

According to the present invention, a method for creating a multi-lingual web page is to be implemented using at least one computer. The method includes:

a) automatically identifying to-be-rendered elements in a source electronic document that is suitable for rendering a web page in a first human language, each of the to-be-rendered elements including to-be-rendered text content in the first human language;

b) generating a list of object elements corresponding to the to-be-rendered elements, the list including translations of the to-be-rendered text contents of the to-be-rendered elements in a second human language; and

c) automatically converting the source electronic document into a multi-lingual electronic document by modifying the to-be-rendered elements into the object elements, each of which includes the to-be-rendered text content, and by inserting into the source electronic document instructions for causing a client device with a browser to refer to the list when rendering the multi-lingual web page such that the multi-lingual web page comprises the to-be-rendered text contents of the object elements in a selected one of the first and second human languages.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating the flow of the preferred embodiment of a method for creating a multi-lingual web page, according to the present invention;

FIG. 2 is a flowchart illustrating the steps of the method of the preferred embodiment;

FIG. 3 is a screenshot of a web page corresponding to an exemplary source electronic document;

FIG. 4 is a diagram illustrating a list of to-be-rendered elements of the exemplary source electronic document that contain respective to-be-rendered text contents;

FIG. 5 is a diagram illustrating a list of object elements of the multi-lingual electronic document that corresponds to the list of the to-be-rendered elements of the exemplary source electronic document;

FIG. 6 is a diagram illustrating a portion of an initial list of object elements that corresponds to the exemplary source electronic document, the object elements including respective to-be-rendered text contents in English;

FIG. 7 is a diagram illustrating a portion of an updated list of object elements that corresponds to the exemplary multi-lingual electronic document, the object elements including respective to-be-rendered text contents in Traditional Chinese;

FIG. 8 is a screenshot of a web page corresponding to the exemplary multi-lingual electronic document; and

FIG. 9 is a screenshot of a browser rendering a web page corresponding to the exemplary source electronic document.

### DETAILED DESCRIPTION OF THE PREFERRED EMBODIMENT

In contrast to conventionally generated multi-lingual web pages, in order to render a web page according to the present invention, a markup language document (i.e., a hypertext markup language document) and a script (i.e., a Java script) are first provided in a server device, such as a server computer or an access point. The markup language document is representative of a web page and includes object elements, each of which is associated with to-be-rendered text content. The script includes the to-be-rendered text contents of the object elements written in a different human language. The server device is then configured to send the markup language document and the script to a client device, such as a client computer or a client mobile phone, with a browser in response to a request for the web page from the client device. The markup language includes instructions for causing the client device to refer to the script when rendering the web page such that the web page comprises the to-be-rendered text contents of the object elements in a selected one of the different human languages. Therefore, the language in which a multi-lingual web page generated according to the present invention is viewed through the client device can be changed without sending another request to the server device from which the multi-lingual web page is received, thereby reducing processing time of client devices and load of server devices.

The present invention further provides a method for creating the multi-lingual web page. The method is to be implemented using at least one computer (e.g., a computer of a web page designer), and includes the steps of:

automatically identifying to-be-rendered elements in a source electronic document that is suitable for rendering a web page in a first human language, each of the to-be-rendered elements including to-be-rendered text content in the first human language;

generating a list of object elements corresponding to the to-be-rendered elements, the list including translations of the to-be-rendered text contents of the to-be-rendered elements in a second human language; and

automatically converting the source electronic document into a multi-lingual electronic document by modifying the to-be-rendered elements into the object elements, each of which includes the to-be-rendered text content, and by inserting into the source electronic document instructions for causing a client device, such as a client computer or a client mobile phone, with a browser to refer to the list when rendering the multi-lingual web page such that the multi-lingual web page comprises the to-be-rendered text contents of the object elements in a selected one of the first and second human languages.

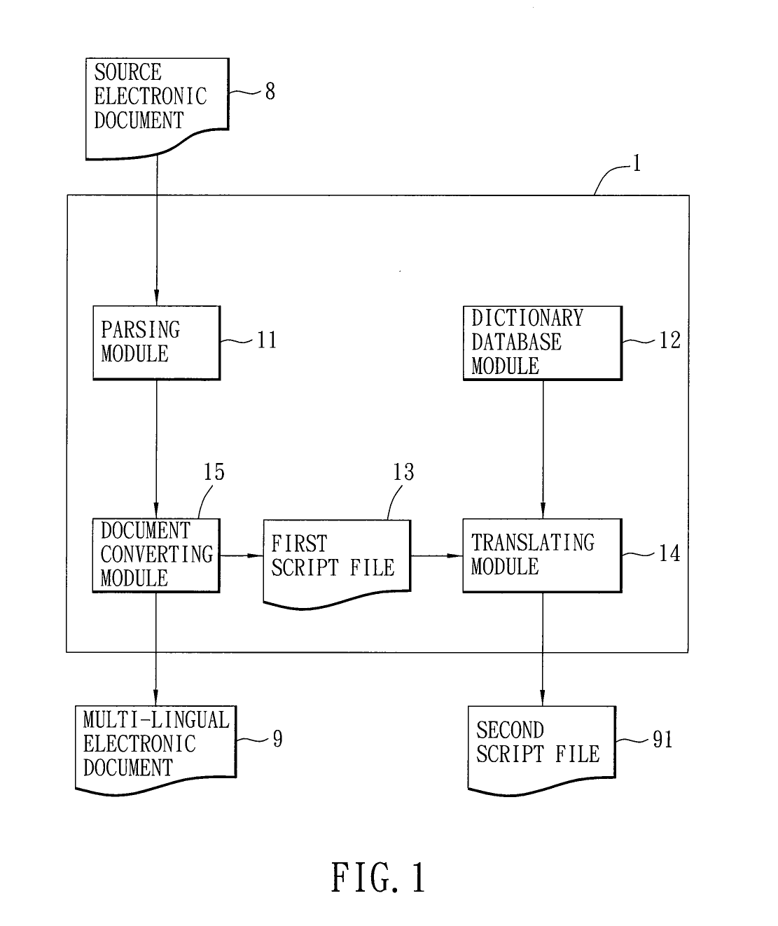

Referring to FIG. 1, in a preferred embodiment, the method is implemented using a system 1 for converting a source electronic document 8 into a multi-lingual electronic document 9. The source electronic document 8 and the multi-lingual electronic document 9 are hypertext markup language (HTML) documents representative of respective web page. The source electronic document 8 is stored in a computer readable storage medium (e.g., a computer hard disk), is suitable for rendering a web page in a first human language (e.g., English) and includes to-be-rendered elements, each of which includes to-be-rendered text content in the first human language. The system 1 includes a parsing module 11, a dictionary database module 12, a translating module 14, and a document converting module 15, the functions of which are described hereinafter.

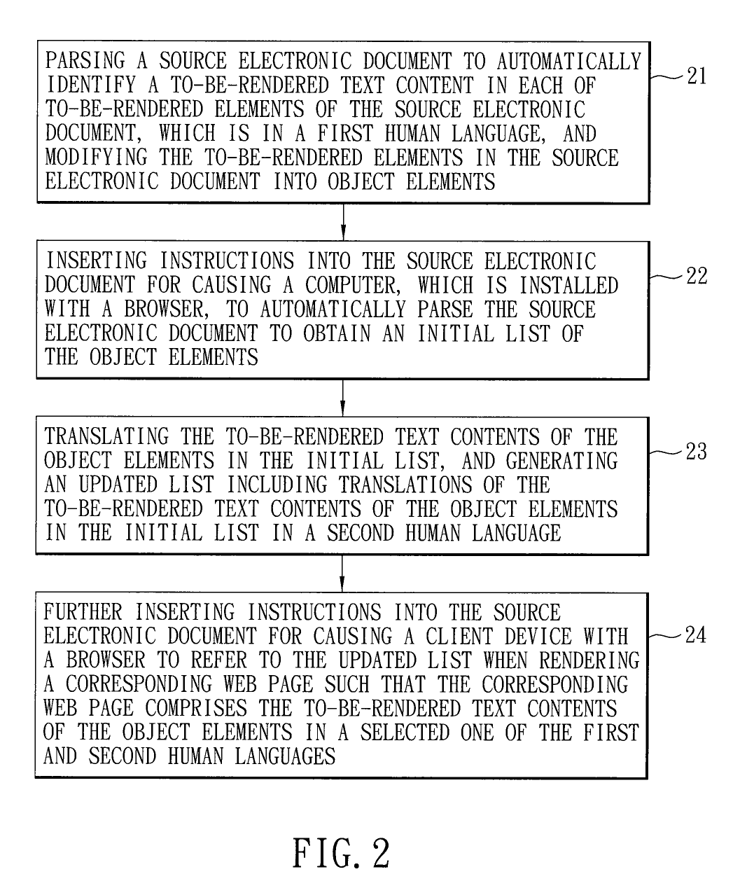

Referring to FIG. 2, the method of the preferred embodiment includes the following steps.

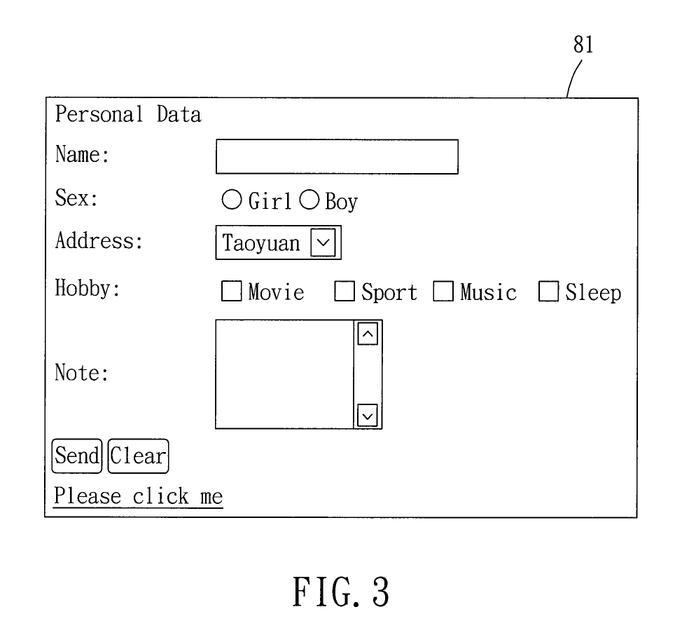

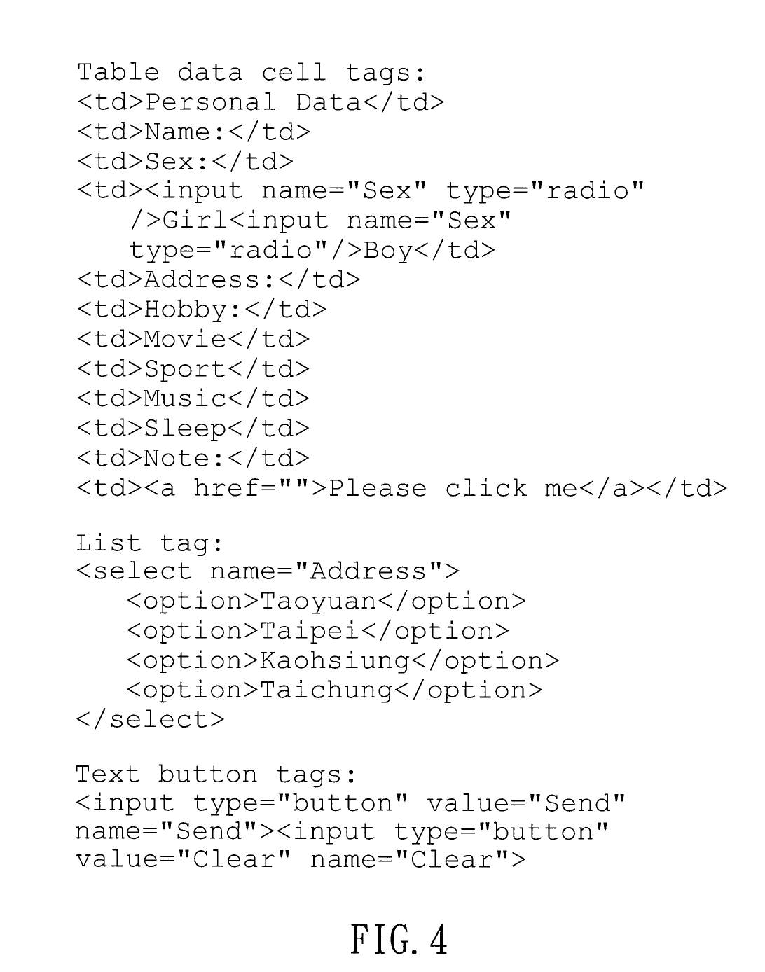

In step 1), the parsing module 11 is configured to parse the source electronic document 8 to automatically identify the to-be-rendered text content in each of the to-be-rendered elements. Referring to FIG. 3, a screenshot 81 of a corresponding web page of an exemplary source electronic document 8 of the present embodiment shows that the source electronic document 8 includes three types of to-be-rendered elements: the table element, the list element, and the button text element. Shown in FIG. 4 is an extract of HTML codes corresponding to the to-be-rendered elements.

The table element contains a pair of an opening table data cell tag (<td>) and a closing table data cell tag (</td>) that enclose the to-be-rendered text content of the table element. In the example, the to-be-rendered text contents of the table elements include “Personal Data”, “Name:”, “Sex:”, “Girl”, “Boy”, “Address:”, “Hobby:”, “Movie”, “Sport”, “Music”, “Sleep”, “Note:”, and “Please click me”.

The list element contains a pair of an opening list tag (<select>) and a closing list tag (</select>) that enclose the to-be-rendered text content of each option of the list element. In the example, the to-be-rendered text contents of the sole list element include “Taoyuan”, “Taipei”, “Kaohsiung”, and “Taichung”. It is to be noted that only “Taoyuan” is shown in the screenshot 81 because “Taoyuan” is a default option.

The button text element contains a button text tag (<input type=“button”>) and further contains the to-be-rendered text content of the button text element. In the example, the to-be-rendered text contents of the text button elements include “Send” and “Clear”.

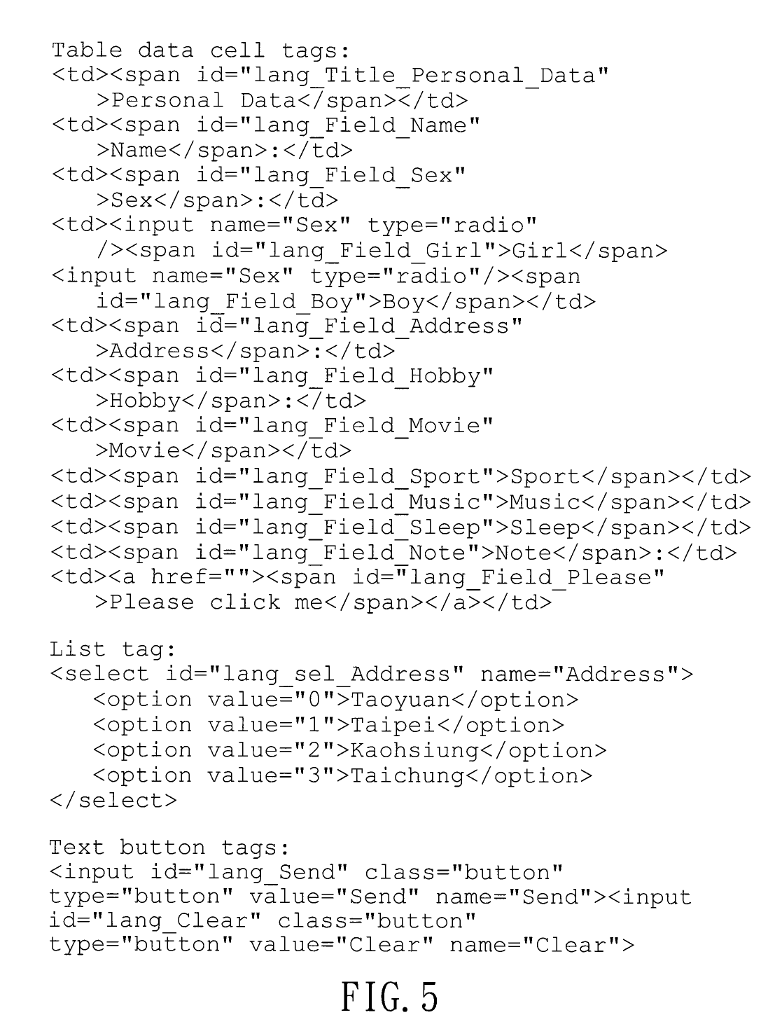

Referring to FIG. 5, once the parsing module 11 has found the to-be-rendered text contents, the document converting module 15 is configured to modify the to-be-rendered elements in the source electronic document 8 into object elements by inserting corresponding identification attributes into the to-be-rendered elements, each of which includes the to-be-rendered text content. In this embodiment, the identification attributes inserted into the to-be-rendered elements conform to the identification (id) attribute of the document object model (DOM) defined by the world wide web consortium (W3C).

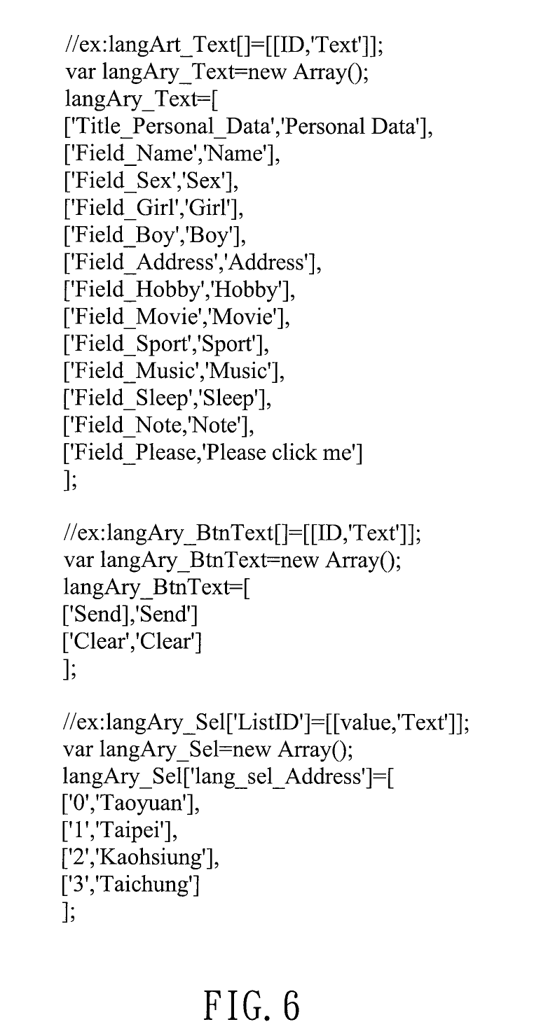

In step 2), the document converting module 15 is further configured for inserting instructions into the source electronic document 8 for causing a device (e.g., a computer), which is installed with a browser, to automatically parse the source electronic document 8 to obtain an initial list of the object elements and to show the initial list on a pop-up window. Shown in FIG. 6 is a portion of the initial list, which includes the to-be-rendered text contents of the object elements. The initial list is then automatically copied to a first script file 13, which, in the present embodiment, is a Java script file. However, generation of the first script file 13 is not limited to the above.

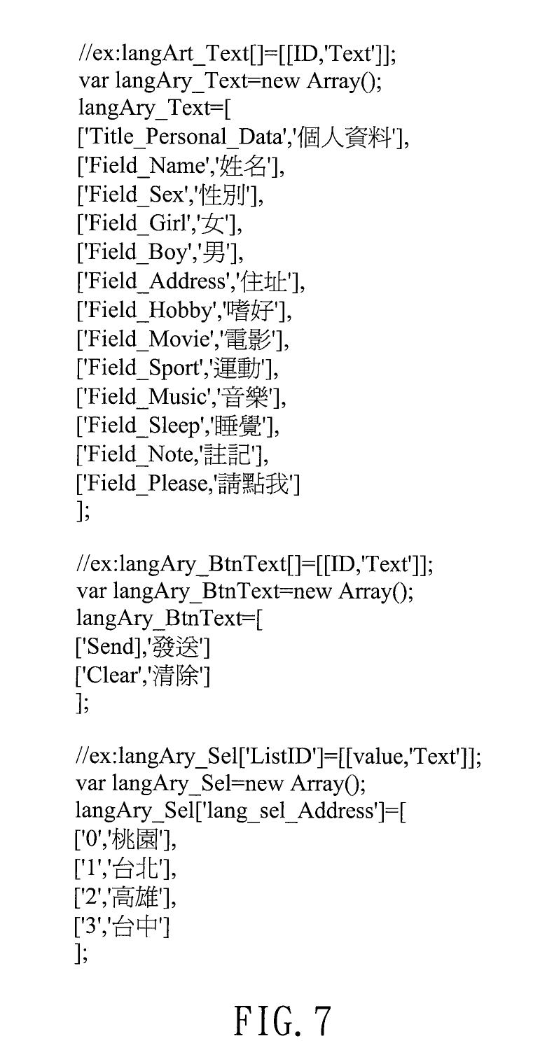

In step 3), the translating module 14 is configured to translate the to-be-rendered text contents of the object elements in the first script file 13 with reference to the dictionary database module 12, which contains information required for rendering the to-be-rendered text contents in a second human language (e.g., Traditional Chinese), and to generate a second script file 91, which is also a Java script file, that includes an updated list including translations of the to-be-rendered text contents of the object elements in the second human language (see FIG. 7). It is to be noted that translation of the to-be-rendered text contents in the first script file 13 into the to-be-rendered text contents in the second script file 91 can also be performed by professional translation services.

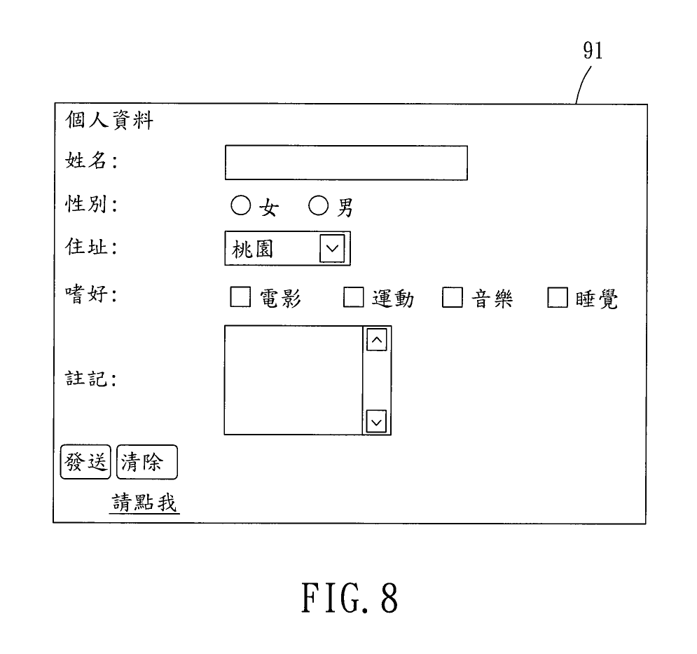

In step 4), the document converting module 15 is further configured to modify the source electronic document 8 such that the pop-up window is not shown when the source electronic document 8 is rendered, to further insert instructions into the source electronic document 8 for causing a client device, such as a client computer or a client mobile phone, with a browser to refer to the updated list in the second script file 91 when rendering a corresponding web page such that the corresponding web page comprises the to-be-rendered text contents of the object elements in a selected one of the first and second human languages, and to output the modified source electronic document 8, which serves as the multi-lingual electronic document 9 for storage in the server device. Shown in FIG. 8 is a screenshot of the web page corresponding to the exemplary multi-lingual electronic document 9 with the to-be-rendered text contents rendered in the second human language (i.e., Traditional Chinese).

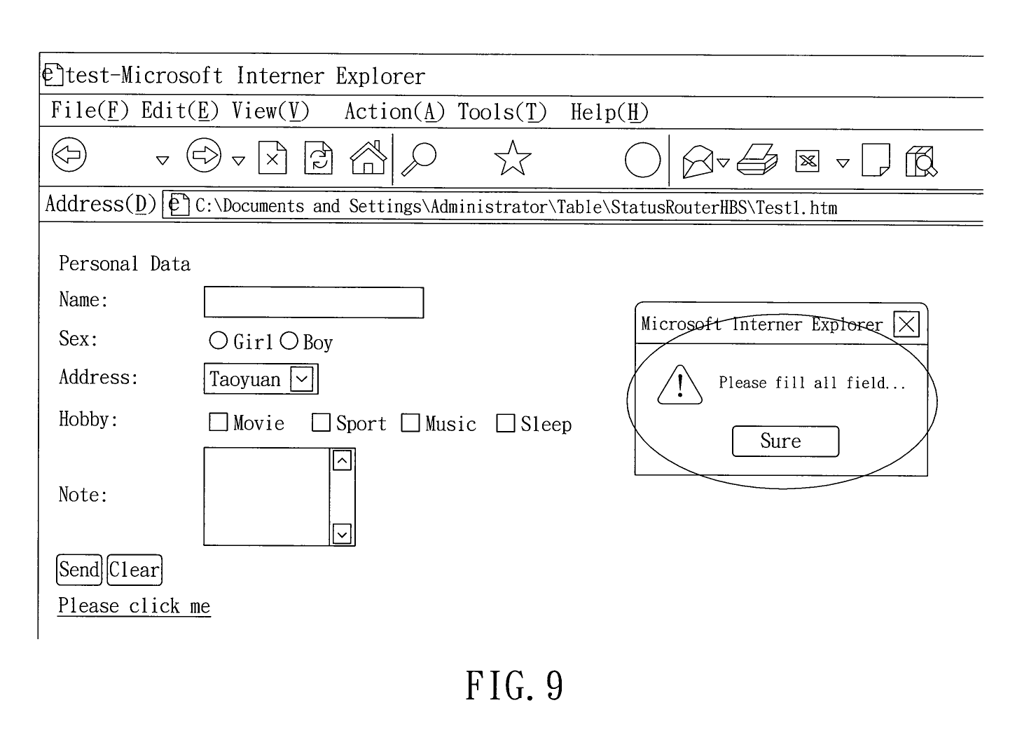

Shown in FIG. 9 is a screenshot of a browser rendering a web page corresponding to the exemplary source electronic document 8. The content text “test” of the title 82 and the content text “Please fill all field . . . ” of the error message 83 corresponding to the source electronic document 8 may also be rendered in the second human language through manual modification of relevant sections in the source electronic document 8. Since modification of the title 82 and the error message 83 may be readily appreciated by those skilled in the art, it will not be described hereinafter for the sake of brevity.

In summary, the method for creating a multi-lingual web page, according to the present invention, has the benefits of less time to prepare, lower requirement of storage medium space, and less difficult to maintain relative to techniques of the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for creating a multi-lingual web page, the method to be implemented using at least one computer and comprising:
a) automatically identifying to-be-rendered elements in a source electronic document that is suitable for rendering a web page in a first human language, each of the to-be-rendered elements including to-be-rendered text content in the first human language;
b) generating a list of object elements corresponding to the to-be-rendered elements, the list including translations of the to-be-rendered text contents of the to-be-rendered elements in a second human language; and
c) automatically converting the source electronic document into a multi-lingual electronic document by modifying the to-be-rendered elements into the object elements, each of which includes the to-be-rendered text content, and by inserting into the source electronic document instructions for causing a client device with a browser to refer to the list when rendering the multi-lingual web page such that the multi-lingual web page comprises the to-be-rendered text contents of the object elements in a selected one of the first and second human languages.

2. The method of claim 1, wherein the to-be-rendered elements are modified into the object elements by inserting corresponding identification attributes into the to-be-rendered elements.

3. The method of claim 2, wherein the identification attributes conform to the identification (id) attribute of the document object model (DOM) defined by the world wide web consortium (W3C).

4. The method of claim 1, wherein the source electronic document and the multi-lingual electronic document are markup language documents.

5. The method of claim 4, wherein the to-be-rendered elements of the source electronic document are independently one of a table element, a list element, and a button text element.

6. The method of claim 1, wherein the list is in the form of a script.

7. A method for rendering a web page, comprising:
providing a markup language document and a script in a server device, the markup language document being representative of a web page and including object elements, each of which is associated with to-be-rendered text content, the script including the to-be-rendered text contents of the object elements written in different human languages; and
configuring the server device to send the markup language document and the script to a client device with a browser in response to a request for the web page from the client device;
wherein the markup language document includes instructions for causing the client device to refer to the script when rendering the web page such that the web page comprises the to-be-rendered text contents of the object elements in a selected one of the different human languages.

8. The method as claimed in claim 7, wherein each of the object elements includes corresponding identification attributes conforming to the identification (id) attribute of the document object model (DOM) defined by the world wide web consortium (W3C).

9. A computer readable storage medium having stored thereon program instructions which, when executed by a device, cause the device to perform steps for creating a multi-lingual web page, said steps comprising:
a) identifying to-be-rendered elements in a source electronic document that is suitable for rendering a web page in a first human language, each of the to-be-rendered elements including to-be-rendered text content in the first human language; and
b) converting the source electronic document into a multi-lingual electronic document by modifying the to-be-rendered elements into corresponding object elements that include the to-be-rendered text contents, and by inserting into the source electronic document instructions for causing a client device with a browser to refer to a list of the object elements when rendering the multi-lingual web page, the list including translations of the to-be-rendered text contents of the to-be-rendered elements in a second human language, such that the multi-lingual web page rendered by the client device comprises the to-be-rendered text contents of the object elements in a selected one of the first and second human languages.

10. The computer readable storage medium as claimed in claim 9, wherein, in step b), the to-be-rendered elements are modified into the object elements by inserting corresponding identification attributes into the to-be-rendered elements.

11. The computer readable storage medium as claimed in 10, wherein the identification attributes conform to the identification (id) attribute of the document object model (DOM) defined by the world wide web consortium (W3C).

12. The computer readable storage medium as claimed in 9, wherein the source electronic document and the multi-lingual electronic document are markup language documents.

13. The computer readable storage medium as claimed in claim 12, wherein the to-be-rendered elements of the source electronic document are independently one of a table element, a list element, and a button text element.

14. The computer readable storage medium as claimed in claim 9, wherein the list is in the form of a script.

15. A computer readable storage medium having stored thereon program instructions which, when executed by a client device with a browser, cause the client device to perform steps for rendering a web page, comprising:
a markup language document representative of a web page and including object elements, each of which is associated with to-be-rendered text content; and
a script including the to-be-rendered text contents of the object elements written in different human languages; and
wherein the markup language document includes instructions for causing the client device to refer to the script when rendering the web page such that the web page comprises the to-be-rendered text contents of the object elements in a selected one of the different human languages.

16. The computer readable storage medium as claimed in claim 15, wherein each of the object elements includes corresponding identification attributes conforming to the identification (id) attribute of the document object model (DOM) defined by the world wide web consortium (W3C).
